(19) United States
(12) Patent Application Publication
(10) Pub. No.: US 2013/0044839 A1
(43) Pub. Date: Feb. 21, 2013

(54) WIRELESS APPARATUS AND PROCESSING METHOD THEREOF

(71) Applicant: KUN-SUI HOU, TAIPEI CITY (TW)

(72) Inventor: KUN-SUI HOU, TAIPEI CITY (TW)

(73) Assignee: REALTEK SEMICONDUCTOR CORP., HSINCHU (TW)

(21) Appl. No.: 13/572,767

(22) Filed: Aug. 13, 2012

(30) Foreign Application Priority Data
Aug. 19, 2011 (TW) 100129678

(51) Int. Cl. H04L 27/06

(52) U.S. Cl. 375/340

(57) ABSTRACT

The present invention relates to a wireless apparatus and the processing method thereof. The wireless apparatus according to the present invention comprises a demodulating circuit, a computing circuit, and a compensating circuit. The demodulating circuit receives and demodulates an input signal for producing a baseband signal. The computing circuit is coupled to the demodulating circuit and receives the baseband signal. It performs inner product on the baseband signal for producing an output signal. The compensating circuit is coupled to the computing circuit, and produces and transmits a compensation signal to the demodulating circuit according to the output signal for adjusting the demodulating circuit. Accordingly, by means of the computing circuit according to the present invention, erroneous outputs sent to the compensation circuit due to erroneous judgment of a signal received with large frequency deviation can he avoided effectively, and hence enhancing the efficiency of the wireless apparatus.

### FIELD OF THE INVENTION

The present invention relates generally to a communication apparatus, and particularly to a wireless apparatus and the processing method thereof.

### BACKGROUND OF THE INVENTION

The receiver in a global positioning system (GPS) needs to have a local oscillator having a highly accurate frequency for acquiring rapidly as well as maintaining synchronization with the carrier frequency, which comes from the satellites, of the GPS. The introduction of GPS will explain the cause of the large frequency deviation in the receiver of a GPS.

If the signal transmitted by a GPS is used for locating, the receiver has to resolve the unknown carrier frequency and the uncertainty in code phase of the spread spectrum signal. The unknown carrier frequency results from the Doppler frequency shift when the satellite and the receiver are moving relatively and from the difference in timing frequencies therebetween. Besides, the uncertainty in code phase is caused by the unknown initial phase difference and the difference in timing frequencies between the receiver and the satellite.

The receiver according to the prior art adopts the trial-and-error method to search the spread spectrum signal hidden in the environmental noise. In the trial-and-error method, the operational circuit generates a duplicated pseudo-noise code of an assumed carrier frequency and phase, and compares the relation between the received pseudo-noise code and the duplicated pseudo-noise code in a period. Then, move the duplicated pseudo-noise code having 1023 symbols and compare again with the received signal until the code matches the received signal. When the matched duplicated pseudo-noise code is found, the output of the operational circuit is the signal having the greatest intensity. If the matched duplicated pseudo-noise code is not found in the 1023 symbols, the carrier frequency of the pseudo-noise code is changed.

After the carrier frequency and the code phase is acquired, the demodulation circuit of the receiver multiplies the received signal with the acquired duplicated pseudo-noise code of the acquired carrier frequency, accumulates the products over a period of the pseudo-noise code, and gives correlated symbols every period. These symbols are sent to the operational circuit to determine the combination of data bits. The symbols multiplying the combination of data hits are sent to the compensation circuit for computing the differences of the carrier phase and the code phase of the received signal with respect to those of the local duplicated signal. These differences are so-called carrier error and code error.

Assume that the operational circuit takes 6 symbols for computation, and includes a first symbol IP1, a second symbol IP2, a third symbol 1P3, a fourth symbol IP4, a fifth symbol IP5, and a sixth symbol IP6. The operational circuit of prior arts sums the symbols according to all possible data bits combinations for finding the maximum value, and select the one with the maximum value as the determined, combination of the data bits. As shown in FIG. 1A, the combination of the maximum value is (IP1+IP2+IP3+IP4+IP5-IP6). Because the sixth symbol IP6 is negative, it is known that the sixth symbol IP6 in the symbols of the received signal has data bit transition. The determined combination of the data bits should be [1 1 1 1 1−1].

Besides, because the system is disposed in moving objects, such as cars, the signal received by the UPS will encounter the problem of large frequency deviation, caused by the large velocity or acceleration, of the moving objects and the small bandwidth of the loop filter. Owing to the large frequency deviation, as shown in FIG. 1B, the symbols of the received signal are arranged in an arc on the constellation plot. IN other words, the received signal includes a first symbol IP1, a second symbol IP2, a third symbol IP3, a fourth symbol IP4, a fifth symbol IP5, and a sixth symbol IP6. Because of large frequency deviation, the first symbol IP1, the second symbol IP2, the third symbol IP3, the fourth symbol IP4, the fifth symbol IP5, and the sixth symbol IP6 are arranged in an arc sequentially. Besides, the sixth symbol IP6 is located at the negative side. The operational circuit of the prior art calculates the maximum value by using the combination of (IP1+IP2+IP3+IP4+IP5−IP6). Nonetheless, the maximum value is caused by large frequency deviation but not data bit transition. The operational circuit, cannot distinguish data bit transition from excess frequency deviation for the received signal, and hence leading to errors while computing the carrier error and the code error, since the symbols multiplying the determined combination are sent to the compensation circuit for computing carrier error and code error. Theoretically. Fourier transformation can be used for judging the amount of frequency deviation and solving the problem. However, if Fourier transformation is adopted, the complexity and cost of the overall system will become extremely high.

Accordingly, the present invention provides a simple and novel wireless apparatus and the processing method thereof for solving the problem described above, Thereby, the problem that the wireless apparatus cannot distinguish effectively data bit transition from excess frequency deviation for a received signal, which can lead to errors in the receiver, can be avoided.

### SUMMARY

One of objectives of the present invention is to provide a wireless apparatus and the processing method thereof. According to the present invention, a computing circuit is used for performing inner product the signal received by the receiving apparatus and then producing an output signal. Thereby, erroneous outputs sent to the compensation circuits due to erroneous judgment of a signal received with large frequency deviation can be avoided effectively, and hence enhancing the accuracy of demodulating signal by the wireless apparatus.

The wireless receiving apparatus according to the present invention comprises a demodulating circuit, an computing circuit, and a compensating circuit. According to the processing method of the present invention, the demodulating circuit receives and demodulates an input signal for producing a baseband signal. The computing circuit is coupled to the demodulating circuit and receives the baseband signal. It performs inner product on the baseband signal to produce an output signal. The compensating circuit is coupled to the computing circuit, and produces and transmits a compensation signal to the demodulating according to the output signal for adjusting the demodulating circuit. Wherein, the demodulating circuit is adjusted according to the compensation signal. Accordingly, by means of the computing circuit according to the present invention, erroneous outputs sent to the compensation circuits due to erroneous judgment of a signal received with large frequency deviation can be avoided effectively, and hence enhancing the accuracy of demodulating signal by the wireless apparatus.

### BRIEF DESCRIPTION OF THE DRAWINGS

FIG. 1A shows a symbol constellation plot of a wireless apparatus according to the prior art;

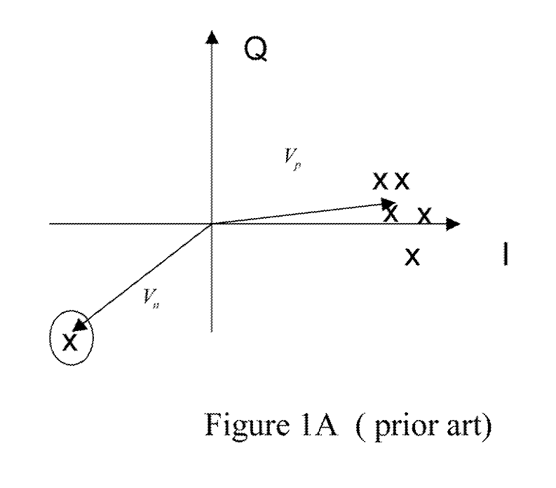

FIG. 1B shows a symbol constellation plot of another wireless apparatus according to the prior art;

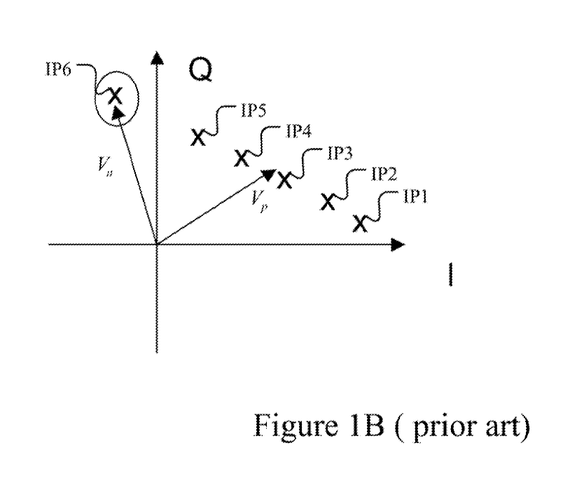

FIG. 2 shows a circuit diagram according to a preferred embodiment of the present invention; and

FIG. 3 shows a symbol constellation plot according to a preferred embodiment of the present invention.

### DETAILED DESCRIPTION

In order to make the structure and characteristics as well as the effectiveness of the present invention to he further understood and recognized, the detailed description of the present invention is provided as follows along with embodiments and accompanying figures.

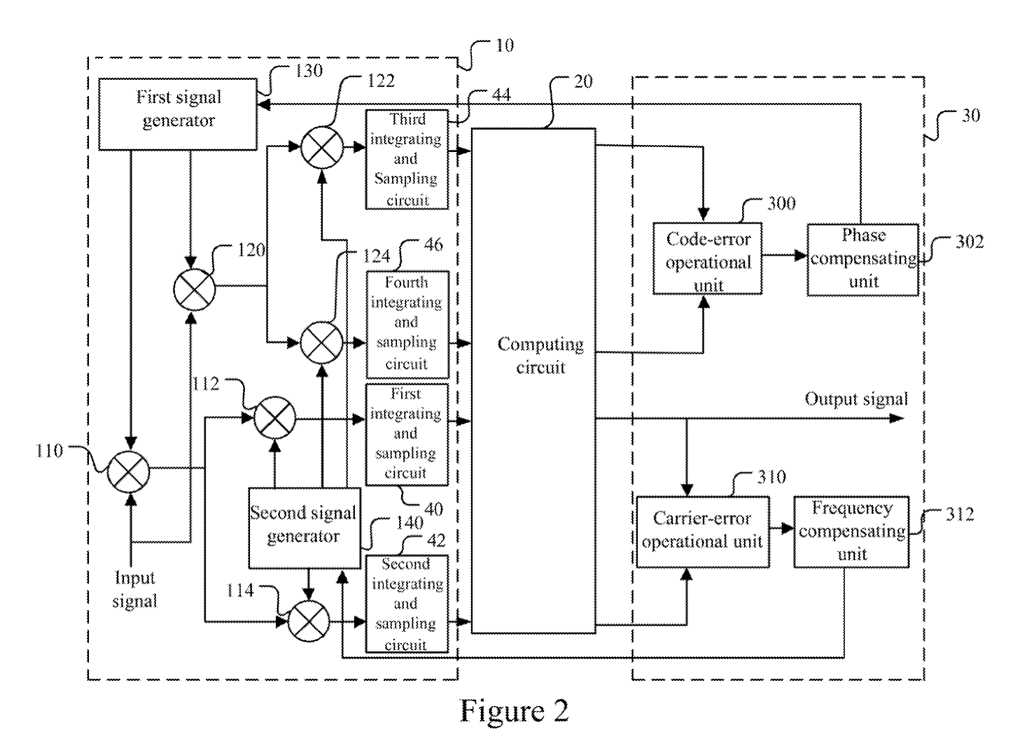

FIG. 2 shows a circuit diagram according to a preferred embodiment of the present invention. As shown in the figure, the wireless apparatus according to the present invention comprises a demodulating circuit 10, a computing circuit 20, and a compensating circuit 30. The demodulating circuit 10 receives and demodulates an input signal for producing a baseband signal, which includes an I signal and a Q signal. According to the present embodiment, the wireless apparatus according to the present invention is applied, to a spread spectrum system. Thereby, the input signal received by the demodulating circuit 10 is a spread spectrum signal. Then, the demodulating circuit 10 demodulates the spread spectrum signal to the baseband signal. The computing circuit 20 is coupled to the demodulating circuit 10 and receives the baseband signal output by the demodulating circuit 10. It also performs inner product on the baseband signal for producing an output signal. The compensating circuit 30 is coupled to the computing circuit 20, and produces and transmits a compensation signal to the demodulating circuit 10 according to the output signal for adjusting the demodulating circuit 10. In other words, the compensating circuit 30 transmits the compensation signal to the demodulating circuit 10 for adjusting the carrier frequency or phase and code frequency or phase of the baseband signal output by the demodulating circuit 10. The compensating circuit 30 processes the output signal to produce the compensation signal. That is, the compensating circuit 30 computes said output signal with arithmetic operations to producing the compensation signal and transmit the compensation signal back to the demodulating circuit 10. Thereby, according to the present invention, the computing circuit 20 performs inner product on the signal received by the wireless apparatus, namely the baseband signal. Consequently, erroneous output signals sent to the compensating circuit 30 due to erroneous judgment of a signal received with large frequency deviation can he avoided effectively, and hence enhancing the accuracy of demodulating signal by the receiving apparatus.

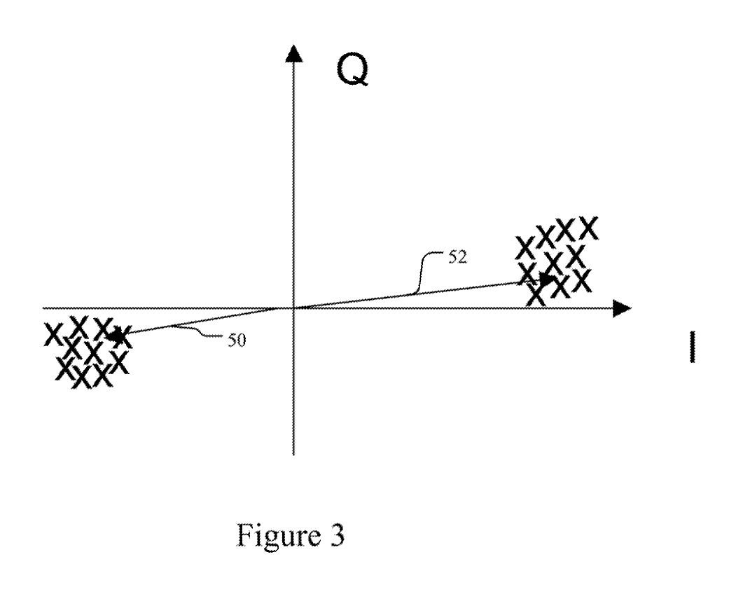

In the following, how the computing circuit 20 according to the present embodiment performs inner product on the baseband signal will be described. First, the baseband signal output by the demodulating circuit 10 includes the I signal and the Q signal. The I signal and the Q signal of the baseband signal are sampled every period. The sampled I signal and Q signal are transmitted to the computing circuit 20, which can give a symbol according to the I signal and the Q signal. The computing circuit 20 will receive the I signal and the Q signal in succession and thus giving a plurality of symbols. The computing circuit 20 generates a first vector and a second vector according to a plurality of symbols and a plurality of data bits of the baseband signal. That is, the computing circuit 20 multiplies the plurality of symbols of the baseband signal by a plurality of data bits, for example, say [ones(1,20)], where ones(m, n) means an m by n matrix with every element as 1. A first vector 50 and a second vector 52 are distributed from the plurality of symbols after multiplication. In other words, the computing circuit 20 divides the plurality of symbols after multiplication into a first group and a second group and averages the plurality of symbols in the first and the second groups for producing the first vector 50 and the second vector 52. As shown in FIG. 3, according to the present embodiment, 20 symbols are used as an example. The plurality of symbols received by the computing circuit 20 are distributed to two groups. Namely, 10 of the 20 symbols are grouped as the first group, while the other 10 symbols are grouped as the second group. The distribution of the 20 symbols can also be grouped according to different requirements. The present invention is not limited to grouping 10 of the 20 symbols. Next, the computing circuit 20 averages the 10 symbols of the first group and the other 10 symbols of the second group, respectively, and produces the first vector 50 and the second vector 52.

Afterwards, the computing circuit 20 performs inner product on the first vector 50 and the second vector 52 for producing an operational value. The computing circuit 20 changes the plurality of data bits sequentially for producing a plurality of operational values, for example, changing the data bits from [ones(1,20)] to [1, −ones(1,19)], [ones(1,2), ones(1,18)], . . . , and then to [ones(1,19), −ones(1,1)]. That is to say, after the computing circuit 20 changes the plurality of data bits, the plurality of symbols of the baseband signal is multiplied by the changed plurality of data bits and giving a new first vector 50 and a new second vector 52. Then the inner product of the new first vector 50 and the new second vector 52 gives a new operational value. In this manner, the computing circuit 20 repeats the steps described above, in which the plurality of data bits are changed sequentially for producing the plurality of operational values. Then, the plurality of symbols multiplying the plurality of data bits with the maximum value of the plurality of operational value are used as the output signal. If the plurality of data bits has 20 bits and the number of the plurality of symbols is 20, the computing circuit 20 will first change the plurality of data bits, respectively, then multiplies the plurality of symbols by the plurality of data bits. Thereby, the computing circuit 20 will produce 20 operational values. The plurality of symbols multiplying the plurality of data bits with the maximum value of the 20 operational values is chosen as the output signal. For example, in FIG. 3, the plurality of data bits with the maximum value is [ones(1,10), −ones(1,10)]. Hence, according to the present invention, the computing circuit 20 performs inner product on the baseband signal and produces the determined combination of data bits for generating the output signal. Consequently, erroneous outputs sent to the compensation circuits due to erroneous judgment of a signal received with large frequency deviation can be avoided effectively, and hence enhancing the efficiency of the receiving apparatus.

Refer again to FIG. 2. The demodulating circuit 10 of the wireless receiving apparatus according to the present invention comprises a first mixer 110, a second mixer 112, a third mixer 114, a fourth mixer 120, a fifth mixer 122, a sixth mixer 124, a first integrating and sampling circuit 40, a second integrating and sampling circuit 42, a third integrating and sampling circuit 44, and a fourth integrating and sampling circuit 46. The first mixer 110 receives the input signal and mixes the input signal with a first reference signal for producing a first mixing signal. The second mixer 112 mixes the first mixing signal with a first carrier signal for producing a first signal of the baseband signal. The third mixer 114 mixes the first mixing signal with a second carrier signal for producing a second signal or the baseband signal. The first integrating and sampling circuit 40 is coupled to the second mixer 112 for integrating and sampling the first signal. According to the present embodiment, the sampling rate of the first integrating and sampling circuit 40 is in the millisecond order for sampling the first signal and producing a plurality of first I signals. Likewise, the second integrating and sampling circuit 42 is coupled to the third mixer 114 for integrating and sampling the second signal and producing a plurality of first. Q signals. The computing circuit 20 receives the plurality of first I signal and the plurality of first Q signal sequentially and gives a plurality of first symbols for subsequent operations of the computing circuit 20. The computing circuit 20 can include a digital logic circuit for performing averaging and inner product operations. Alternatively, the computing circuit 20 can have built-in hardware description language programs or other operational program software for performing averaging and inner product operations.

Likewise, The fourth mixer 120 receives the input signal and mixes the input signal with a second reference signal for producing a second mixing signal. The fifth mixer 122 mixes the second mixing signal with a third carrier signal for producing a third signal of the baseband signal. The sixth mixer 124 mixes the second mixing signal with a fourth carrier signal for producing a fourth signal of the baseband signal. The third integrating and sampling circuit 44 is coupled to the fifth mixer 122 for integrating and sampling the third signal output by the filth mixer 122 and producing a second I signal. The fourth integrating and sampling circuit 46 is coupled to the sixth mixer 124 for integrating and sampling the fourth signal output by the sixth mixer 124 and producing a second Q signal. The sampling rates of the third integrating and sampling circuit 44 and the fourth integrating and sampling circuit 46 are in the millisecond order for sampling the third and the fourth signals and producing a plurality of second I signals and a plurality of second Q signals.

In addition, the demodulating circuit 10 according to the present invention further comprises a first signal generator 130 and a second signal generator 140. The first signal generator 130 is used for generating the first and the second reference signals. The second signal generator 140 is used for generating the first and the second carrier signals. The first signal generator 130 is a code generator; the second signal generator 140 is a carrier signal generator. The mixers and signal generators described above are technologies well known to a person having ordinary skill in the art, and hence will be described in more details.

The compensating circuit 30 according to the present invention comprises a code-error operational unit 300, a phase compensating unit 302, a code-error operational unit 310, and a frequency compensating unit 312. The code-error operational unit 300 is coupled to the computing circuit 20. It uses the output signal of the computing circuit 20 for calculating a code error of the baseband signal. The phase compensating unit 302 is coupled to the code-error operational unit 300. It produces and transmits a phase compensation signal according to the code error and thus adjusting the code frequency or phase of the baseband signal output by the first signal generator 130. The phase compensating unit 302 is a filter. Besides, the phase compensating unit 302 produces the phase compensation signal for a period and then adjusts the demodulating circuit 10. On the other hand, the carrier-error operational unit 310 of the compensating circuit 30 is coupled to the computing circuit 20. It uses the output signal of the computing circuit 20 for calculating a carrier error of the baseband signal. The frequency compensating unit 312 is coupled to the carrier-error operational unit 310. It produces and transmits a frequency compensation signal according to the carrier error and thus adjusting the carrier frequency or phase of the baseband signal output by the second signal generator 140. The frequency compensating unit 312 is a filter. Besides, the frequency compensating unit 312 produces the frequency compensation signal for a period and then adjusts the demodulating circuit 10. Furthermore, the first mixer 100, the second mixer 102, the third mixer 104, the first signal generator 130, the computing circuit 20, the code-error operational unit 300, and the phase compensating unit 302 of the wireless apparatus according to the present invention form a delay-locked loop (DLL). The fourth mixer 110, the fifth mixer 112, the sixth mixer 114, the second signal generator 140, the computing circuit 20, the carrier-error operational unit 310, and the frequency compensating unit 312 of the wireless apparatus according to the present invention form a phase-locked loop (PLL).

To sum up, the present invention relates to a wireless apparatus and the processing method thereof The wireless apparatus according to the present invention comprises a demodulating circuit, a computing circuit, and a compensating circuit. The demodulating circuit receives and demodulates an input signal for producing a baseband signal. The computing circuit is coupled to the demodulating circuit and receives the baseband signal. It performs inner product on the baseband signal for producing an output signal. The compensating circuit is coupled to the computing circuit, and produces and transmits a compensation signal to the demodulating circuit according to the output signal for adjusting the demodulating circuit Accordingly, by means of the computing circuit according to the present invention, erroneous outputs sent to the compensation circuits due to erroneous judgment of a signal received with large frequency deviation can be avoided effectively, and hence enhancing the efficiency of the wireless apparatus.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An apparatus, comprising:
a demodulating circuit, receiving an input signal, demodulating said input signal, and producing a baseband signal;
a computing circuit, coupled to said demodulating circuit, receiving said baseband signal, performing inner product on said baseband signal to produce an output signal; and
a compensating circuit, coupled to said computing circuit, producing a compensation signal according to said output signal, transmitting said compensation signal to the demodulating circuit;
wherein the demodulating circuit is adjusted according to said compensation signal.

2. The apparatus of claim 1, wherein said computing circuit generates a first vector and a second vector according to a plurality of symbols and a plurality of data bits of said baseband signal, and performs inner product on said first vector and said second vector to produce an operational value, wherein said computing circuit produces the output signal according to said plurality of operational values.

3. The apparatus of claim 2, wherein said computing circuit divides said plurality of symbols into a first group and a second group, averages said plurality of symbols in said first group and said second group, and produces said first vector and said second vector.

4. The apparatus of claim 1, wherein said compensating circuit computes said output signal with arithmetic operations to produce said compensation signal.

5. The apparatus of claim 1, wherein said compensating circuit comprises:
a code-error operational unit, coupled to said computing circuit, to generate a code error of said baseband signal according to said output signal; and
a phase compensating unit, coupled to said code-error operational unit, to produce a phase compensation signal according to said code error of said baseband signal;
wherein the phase of said baseband signal is adjusted according to said phase compensation signal.

6. The apparatus of claim 1, wherein said compensating circuit comprises:
a carrier-error operational unit, coupled to said computing circuit to generate a carrier error of said baseband signal according to said output signal; and
a frequency compensating unit, coupled to said carrier-error operational unit to produce a frequency compensation signal according to said carrier error of said baseband signal;
wherein the frequency of said baseband signal is adjusted according to said frequency compensation signal.

7. A processing method of a receiving apparatus, the r method comprising:
receiving an input signal;
demodulating said input signal to produce a baseband signal; and
performing inner product on said baseband signal to produce an output signal.

8. The method of claim 7, further comprising:
calculating the error of said baseband signal according to said output signal, and producing a compensation signal; and
adjusting at least one of phase and frequency of said baseband signal according to said compensation signal.

9. The method of claim 8, wherein said step of calculating the error of said baseband signal comprises:
computing said output signal with arithmetic operation for producing said compensation signal.

10. The method of claim 7, wherein said step of performing inner further comprises;
multiplying a plurality of data bits by a plurality of symbols of said baseband signal;
generating a first vector and a second vector according to said multiplied plurality of symbols; and
performing inner product on said first vector and said second vector, to produce an operational value;
producing the said output signal according to said plurality of operational values.

11. The method of claim 10, wherein said step of finding a first vector and a second vector further comprises:
dividing said plurality of symbols into a first group and a second group; and
averaging said plurality of symbols in said first group and said second group to produce said first vector and said second vector.

12. The method of claim 7, wherein said compensation signal comprises a phase compensation signal and a frequency compensation signal.
